(19) United States
(12) Patent Application Publication
(10) Pub. No.: US 2015/0188251 A1
(43) Pub. Date: Jul. 2, 2015

(54) POWER PLUG

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JIAN-MING XIAO, Shenzhen (CN)

(21) Appl. No.: 14/500,104

(22) Filed: Sep. 29, 2014

(30) Foreign Application Priority Data
Dec. 26, 2013 (CN) 201310729982.3

(51) Int. Cl. H01R 13/453

(52) U.S. Cl. CPC H01R 13/4538

(57) ABSTRACT

A power plug includes a body, and one or more electrically conductive elements. Each of the one or more electrically conductive elements having a conductive insert extending out from the body and a conductive base portion enclosed, and electrically insulated, by the body. The each base portion of the one or more conductive elements is connectable to a conductive input. At least one of the conductive insert of the one or more conductive elements has a first portion and a second portion, the first portion of the insert being closer to the body and having a smaller cross-sectional area than the second portion and the first portion being substantially enclosed by an insulated housing. An insulated housing substantially encloses the first portion of the at least one conductive insert having a first and second portion.

### FIELD

The subject matter herein generally relates to power plugs, and particularly, to a safe power plug.

### BACKGROUND

A variety of safe electrical plugs have been proposed which include various types of sleeves or covers that are automatically extendable and retractable relative to the terminals of the plug and encompass the outer ends of the terminals when the plug is not engaged in an electrical outlet or receptacle.

### BRIEF DESCRIPTION OF THE DRAWINGS

Implementations of the present technology will now be described, by way of example only, with reference to the attached figures.

FIG. 1 is a partial, perspective view of a first embodiment of a power plug.

FIG. 2 is an isometric view of the pins of the power plug of FIG. 1.

FIG. 3 is a cross-sectional view of the power plug taken along line III-III of FIG. 1.

FIG. 4 is a partial, perspective view of a second embodiment of a power plug.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising”, when utilized, means “including, but not necessarily limited to”; it specifically indicates open-ended inclusion or membership in the so-described combination, group, series and the like.

The present disclosure is described in relation to a power plug.

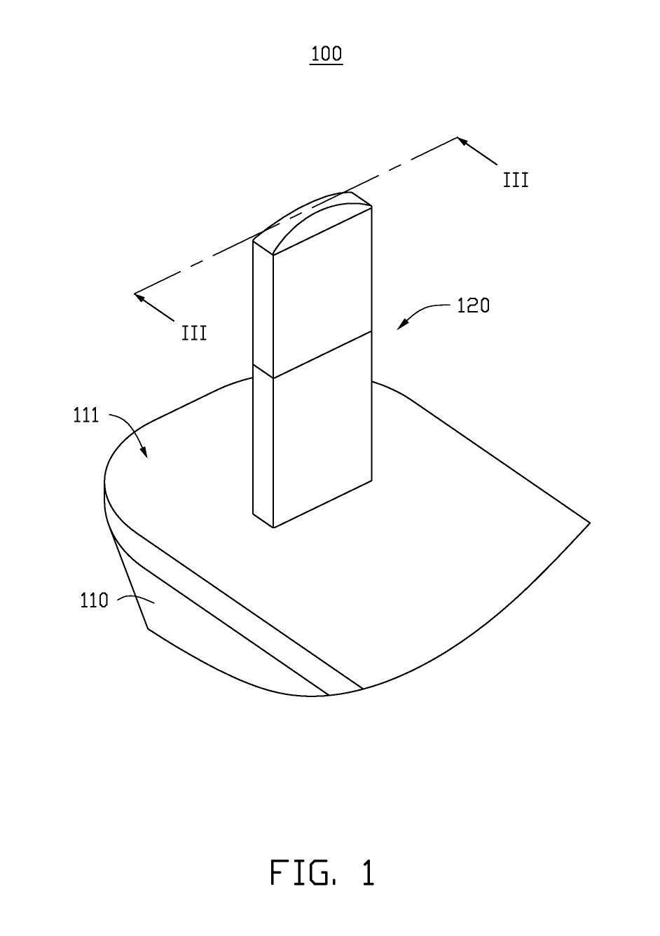

FIG. 1 illustrates a power plug 100 according to a first embodiment of this disclosure. The power plug 100 is configured for electrically connecting with a power socket (not shown) and can include an insulated body 110, and one or more conductive elements 120 assembled to the insulated body 110. The insulated body 110 can define an abutting surface 111 adjacent to the one or more conductive elements 120. The abutting surface 111 can correspond to the power socket and can be a substantially planar. The insulated body 110 can be integrally formed with a resin material, such as polyvinyl chloride.

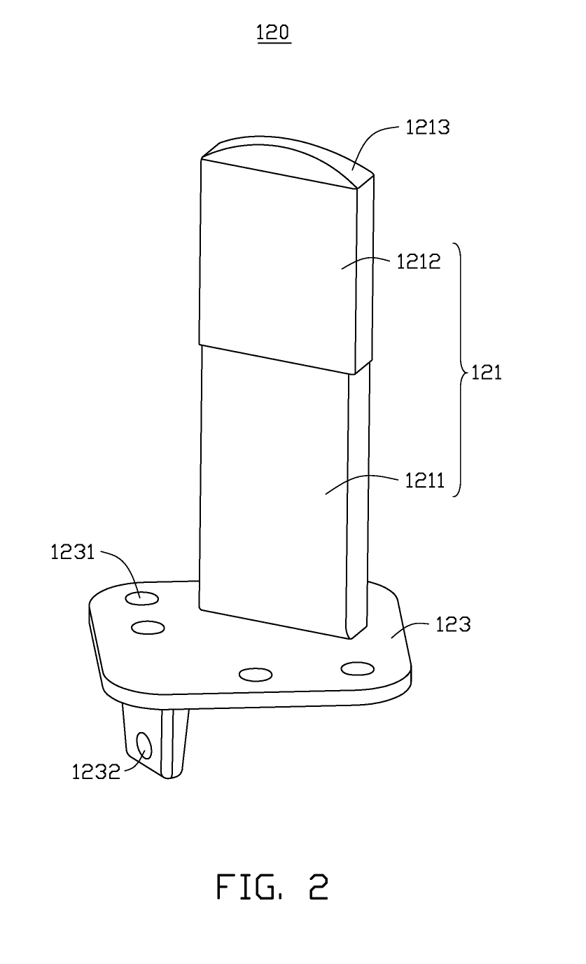

FIG. 2 illustrates that each of the one or more conductive elements 120 can be integrally formed with a metal, and include a conductive insert 121 extending out from the insulated body 110. The conductive insert 121 can be configured to match the power socket. A conductive base portion 123 is connected to an end of the conductive insert 121, enclosed, and electrically insulated, by the insulated body 110. The conductive insert 121 and the conductive base portion 123 can be a substantially rectangular plate, and the conductive insert 121 can be perpendicular to the conductive base portion 123. In the illustrated embodiment, the one or more conductive elements 120 can be made of copper, and the processing method of the one or more conductive elements 120 can include a metal stamping, forging, and computer numerical control (CNC) etc.

The conductive insert 121 can define a first portion 1211 adjacent to the conductive base portion 123, and being closer to the insulated body 110. The first portion 1211 can surround the end of the conductive insert 121 neighboring the conductive base portion 123, and can substantially occupy half of the conductive insert 121. In other embodiments, the conductive insert 121 can be substantially cylindrical, and the first portion 1211 can be substantially annular.

In the illustrated embodiment, the first portion 1211 can have a same depth, or can be a quarter of a thickness of the conductive insert 121.

The conductive insert 121 can include a second portion 1212 configured for electrically connecting with the power socket, and the second portion 1212 is connected with the first portion 1211 and located away from conductive base portion 123. The first portion 1211 can have a smaller cross-sectional area than the second portion 1212. The conductive insert 121 can include an arched shaped edge 1213 defined at a terminal of the second portion 1212. As a result, it is inconvenient to insert the conductive insert 121 into the power socket.

The conductive base portion 123 can include a plurality of through holes 1231 and define a wiring hole 1232, each of the plurality of through holes 1231 and the wiring hole 1232 can be circular. In other embodiments, the through holes 1231 and the wiring hole 1232 can be other shapes.

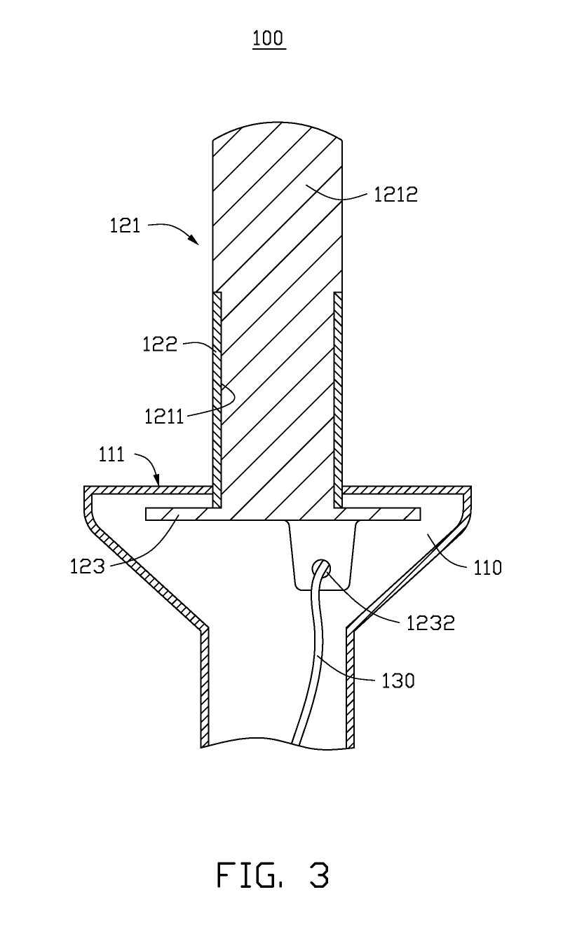

FIG. 3 illustrates that a wire 130 can be inserted into the insulated body 110, and a terminal of the wire 130 can be electrically connected to the conductive insert 121 by passing through the wiring hole 1232. An insulated housing 122 can surround, and be attached to, the conductive insert 121. The first portion 1211 can be substantially enclosed by the insulated housing 122. In the illustrated embodiment, the insulated housing 122 can be made of polycarbonate (PC), and the insulated housing 122 can be integrated with the one or more conductive elements 120 by insert molding. In other embodiments, the insulated housing 122 can substantially enclose the first portion 1211 of the at least one conductive insert 121 having the first portion 1211 and the second portion 1212.

In operation, the insulated housing 122 is integrally formed with the first portion 1211, thus the insulated housing cannot be easily removed from the first portion 1211. In other embodiments, the thickness of the insulated housing 122 can be slightly less than the depth of the first portion 1211, and the ends of the insulated housing 122 can be defined by chamfering (not shown).

The insulated housing 122 can be tightly contacted with the insulated body 110. When the conductive base portion 123 is inserted into the insulated body 110, the plurality of through holes 1231 can be filled with a part of the insulated body 110, as a result, the one or more conductive elements 120 can be tightly connected with the insulated body 110.

In operation, the insulated housing 122 surrounding the first portion 1211 can prevent the risk of electrical shock. Simultaneously, the insulated housing 122 made of polycarbonate can be nonflammable, and the power plug 100 can be fireproof.

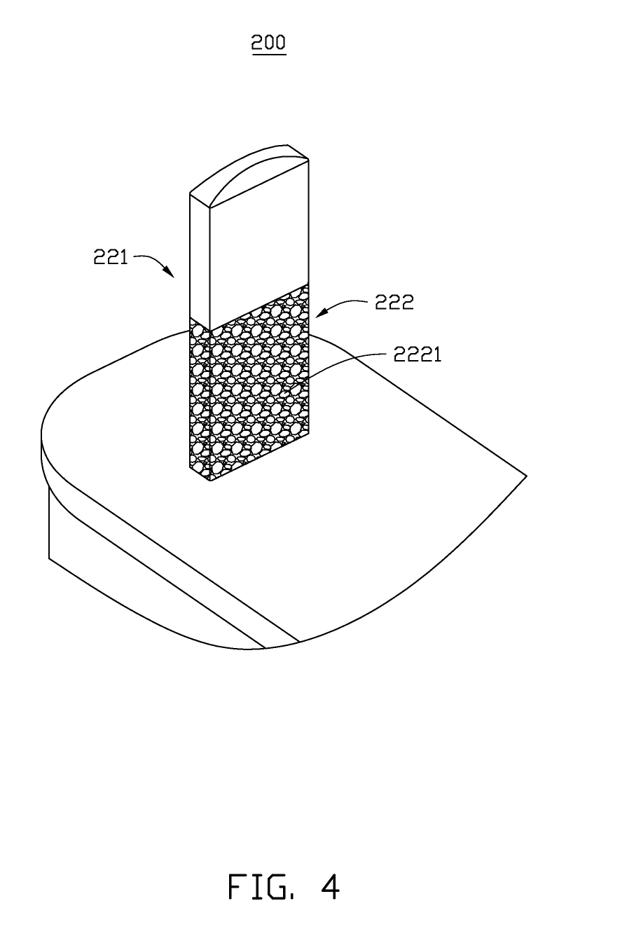

FIG. 4 illustrates a power plug 200 in a second embodiment of this disclosure. The power plug 200 can include a conductive insert 221, and an insulated housing 222 surrounding, and attached to, the conductive insert 221. The power plug 200 can be the same as in the first embodiment, except that the surface of the insulated housing 222 can be a dull polish surface 2221. The dull polish surface 2221 can increase the friction between the conductive insert 221 and the power socket, thereby the power plug 200 can avoid popping out of the power socket.

The embodiments shown and described above are only examples. Many details are often found in the art such as the other features of a power plug. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A power plug comprising:
a body;
one or more electrically conductive elements, each of the one or more electrically conductive elements having a conductive insert extending out from the body and a conductive base portion enclosed, and electrically insulated, by the body;
wherein, the each base portion of the one or more conductive elements is connectable to a conductive input;
wherein, at least one of the conductive insert of the one or more conductive elements has a first portion and a second portion, the first portion of the insert being closer to the body and having a smaller cross-sectional area than the second portion and the first portion being substantially enclosed by an insulated housing;
wherein, an insulated housing substantially encloses the first portion of the at least one conductive insert having a first and second portion.

2. The power plug as claimed in claim 1, wherein the insulated housing is made of polycarbonate.

3. The power plug as claimed in claim 1, wherein the second portion is connected with the first portion, and the first portion occupy half of the conductive insert.

4. The power plug as claimed in claim 1, wherein the conductive base portion is connected to one end of the conductive insert, and the conductive insert is perpendicular to the conductive base portion.

5. The power plug as claimed in claim 4, wherein the conductive base portion comprises a plurality of through holes and a wiring hole.

6. The power plug as claimed in claim 5, wherein a wire is inserted into the insulated body, and a terminal of the wire is electrically connected to the conductive insert by passing through the wiring hole.

7. The power plug as claimed in claim 5, wherein the through holes are filled with a part of the insulated body.

8. The power plug as claimed in claim 1, wherein the conductive insert comprises an arched shaped edge defined at a terminal of the second portion.

9. The power plug as claimed in claim 1, wherein the surface of the insulated housing is a dull polish surface.

10. The power plug as claimed in claim 1, wherein the conductive insert is cylindrical.

11. The power plug as claimed in claim 1, wherein the conductive insert is a substantially rectangular plate.

12. The power plug as claimed in claim 1, wherein each of the one or more electrically conductive elements is made of copper.

13. The power plug as claimed in claim 1, wherein the conductive insert include an arched shaped edge defined at a terminal of the second portion.
